(19) United States
(12) Patent Application Publication
(10) Pub. No.: US 2023/0081012 A1
(43) Pub. Date: Mar. 16, 2023

(54) Locating Mobile Device Using Anonymized Information

(71) Applicant: QUALCOMM Incorporated, San Diego, CA (US)

(72) Inventors: Kyu Woong HWANG, Daejeon (KR); Sungrack YUN, Seongnam (KR); Jaewon CHOI, Seoul (KR); Seunghan YANG, Incheon (KR); Janghoon CHO, Seoul (KR); Hyoungwoo PARK, Seoul (KR); Hanul KIM, Uijeongbu-si (KR)

(21) Appl. No.: 17/474,679

(22) Filed: Sep. 14, 2021

(51) Int. Cl. H04W 12/02; H04W 64/00; G06F 21/62

(52) U.S. Cl. CPC H04W 12/02; H04W 64/003; G06F 21/6245

(57) ABSTRACT

Embodiments include methods of assisting a user in locating a mobile device executed by a processor of the mobile device. Various embodiments may include a processor of a mobile device obtaining information useful for locating the mobile device from a sensor of the mobile device configured to obtain information regarding surroundings of the mobile device, anonymizing the obtained information to remove private information, and uploading the anonymized information to a remote server in response to determining that the mobile device may be misplaced. Anonymizing the obtained information may include removing speech from an audio input and compiling samples of ambient noise for inclusion in the anonymized information. Anonymizing the obtained information to remove private information includes editing an image captured by the mobile device to make images of detected individuals unrecognizable.

### BACKGROUND

Modern mobile devices, including cell phones, laptops, tablets, smart watches, and similar devices, come equipped with “find my phone” or other named locating features that use global navigation satellite system (GNSS) functionality, such as a Global Positioning System (GPS) receiver, to determine a last detected location of the mobile device in order to help a user locate the device when missing. However, the somewhat inaccurate nature of GPS can sometimes suggest a mobile device was lost at a location that the mobile device was not located.

### SUMMARY

Various aspects include methods and mobile devices implementing the methods of assisting a user in locating a mobile device executed by a processor of the mobile device. Various aspects may include obtaining information useful for locating the mobile device from a sensor of the mobile device configured to obtain information regarding surroundings of the mobile device, anonymizing the obtained information to remove private information, and uploading the anonymized information to a remote server. In some aspects, uploading the anonymized information to the remote server may include uploading the anonymized information to the remote server in response to determining that the mobile device may be misplaced. In some aspects, anonymizing the obtained information to remove private information may include removing speech from an audio input of the mobile device to compile one or more samples of ambient noise from the surroundings of the mobile device for inclusion in the anonymized information.

In some aspects, anonymizing the obtained information to remove private information includes determining which of one or more predetermined categories of ambient noise are included within an audio input of the mobile device, wherein the anonymized information indicates the determined one or more predetermined categories of ambient noise. In some aspects, the anonymized information may indicate a text description of ambient noise that includes the determined one or more predetermined categories of ambient noise. In some aspects, anonymizing the obtained information to remove private information may include converting speech to text and generating a generalized description of the converted speech, wherein the anonymized information includes the generalized description of the speech converted to text. In some aspects, anonymizing the obtained information to remove private information includes editing an image captured by a video input of the mobile device to make images of individuals detected within the captured image unrecognizable, wherein the anonymized information includes the edited image.

In some aspects, anonymizing the obtained information to remove private information may include editing an image captured by a video input of the mobile device to make unrecognizable identifying information associated with an individual detected within the captured image, wherein the anonymized information includes the edited image. In some aspects, anonymizing the obtained information to remove private information includes determining which of one or more predetermined categories of visual elements are included within an image captured by a camera of the mobile device, wherein the anonymized information indicates the determined one or more predetermined categories of visual elements. In some aspects, anonymizing the obtained information to remove private information may include compiling a text description of one or more visual elements within an image captured by a camera of the mobile device, wherein the anonymized information indicates the compiled text description.

Further aspects include a mobile device including a processor configured with processor-executable instructions to perform operations of any of the methods summarized above. Further aspects include a non-transitory processor-readable storage medium having stored thereon processor-executable software instructions configured to cause a processor to perform operations of any of the methods summarized above. Further aspects include a processing device for use in a mobile device and configured to perform operations of any of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 is a schematic diagram illustrating example systems configured for assisting a user in locating a mobile device executed by a processor of the mobile device.

FIG. 2 is a schematic diagram illustrating components of an example system in a package for use in a mobile device in accordance with various embodiments.

FIG. 3 is a process flow diagram of an example method of assisting a user in locating a mobile device that may be executed by a processor of the mobile device according to various embodiments.

FIG. 4 is a component block diagram of a network server computing device suitable for use with various embodiments.

FIG. 5 is a component block diagram of a mobile device suitable for use with various embodiments.

### DETAILED DESCRIPTION

Various aspects will be described in detail with reference to the accompanying drawings. Wherever possible, the same reference numbers will be used throughout the drawings to refer to the same or like parts. References made to particular examples and embodiments are for illustrative purposes and are not intended to limit the scope of the various aspects or the claims.

Location information obtained by GNSS receivers (e.g., GPS) of a last know location of a mobile device can be useful for locating the device within a general location, such as at home or at a place of work. However, the accuracy (or “granularity”) of GNSS (e.g., GPS) location information means that a user must search within a relatively large area, which can be difficult in a location with many hiding spots, such as a home. Since granularity of GNSS (e.g., GPS) location information may be too large to assist a user to find a lost mobile device in some locations, various embodiments include methods to make available to a user information about the environment in which the mobile device is located. In various embodiments, a mobile device may capture ambient audio and/or image surroundings, as well as obtain other environment or contextual information (e.g., orientation, temperature, etc.) that are wirelessly transmitted to a remote server or similar repository, which retains the information in a format that can later be provided to a user in response to a query to help the user locate the mobile device. Thus, GNSS (e.g., GPS) location information can lead a user to the general area in which the mobile device is present, while recorded images, sounds and other contextual information can help the user pinpoint the location of the mobile device. However, many jurisdictions make it illegal to regularly record audio and/or images of people without their explicit consent due to privacy issues. For example, in many countries it is illegal to record conversations without the permission of the speakers. As another example, in some many countries it is illegal to use pictures of individuals for commercial purposes without their permission. To address such legal restrictions, various embodiments include methods performed by a processor of the mobile device analyze audio and/or images recorded the mobile device, anonymizing the obtained information to remove private information, and then upload the anonymized information to a remote server, which can later provide the anonymized information to the user to help locate the device.

As used herein, the terms “mobile device” refers to a portable computing device with at least a processor, communication systems, and memory, particularly with wireless communication capabilities. For example, mobile devices may include any one or all of cellular telephones, smartphones, portable mobile devices, personal or mobile multi-media players, laptop computers, tablet computers, 2-in-1 laptop/table computers, smartbooks, ultrabooks, palmtop computers, wireless electronic mail receivers, multimedia Internet-enabled cellular telephones, wearable devices including smart watches, entertainment devices (e.g., wireless gaming controllers, music and video players, satellite radios, etc.), and similar electronic devices that include a memory, wireless communication components and a programmable processor. In various embodiments, mobile devices may be configured with memory and/or storage. Additionally, mobile devices referred to in various example embodiments may be coupled to or include wired or wireless communication capabilities implementing various embodiments, such as network transceiver(s) and antenna(s) configured to communicate with wireless communication networks.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high-speed communication circuitry and packaged in close proximity, such as on a single motherboard or in a single wireless device. The proximity of the SOCs facilitates high speed communications and the sharing of memory and resources.

As used herein, the terms “component,” “system,” “unit,” “module,” and the like include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

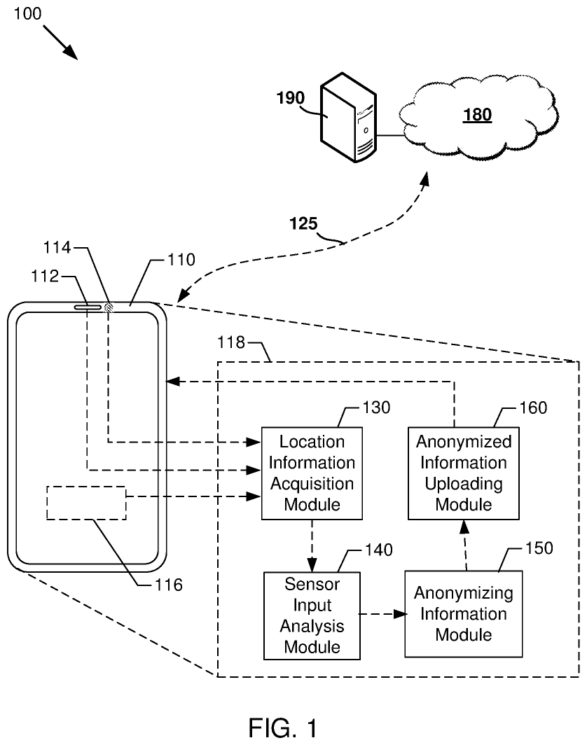

FIG. 1 illustrates an environment 100 with mobile device 110 configured to assist a user in locating the mobile device 110 if/when lost, stolen, or otherwise needs to be found, in accordance with various embodiments. In particular, the mobile device 110 may be a mobile device configured to obtain information useful for locating the mobile device 110 from a sensor of the mobile device 110. The sensor may be one or more sensors configured to collect data regarding surroundings of the mobile device 110, including sounds, imagery, and other sensor inputs from the things and conditions around the mobile device 110. In various embodiments, the mobile device 110 may be configured to anonymize the obtained information to remove private information and comply with privacy regulations. The mobile device 110 may upload the anonymized information to one or more remote computing device(s) 190 (e.g., a server).

As used herein, the term “anonymize” refers to the act of removing identifying particulars or details from recorded information, especially recorded sounds and images. For example, anonymizing recorded audio may include determining whether spoken words are included in the recorded sounds, and distorting such sounds when detected to render the words or voice of the speaker unrecognizable. As another example, when speech is detected, the anonymized information may be simply an indication that speech can be heard in the vicinity of the mobile device. In still images and recorded video, anonymizing may involve analyzing images to detect the presence of people, and then altering portions of images (e.g., masking over or fuzzy faces or other body parts).

The remote computing device(s) 190 may be part of a cloud-based computing network configured to help the mobile device 110, and others like it, assisting users in locating mobile devices. The remote computing device 190 may be configured to store the anonymized information for later access by the user (e.g., to find the mobile device that has gone missing). In this way, using a separate computing device (not illustrated), the user may later access the anonymized information from the remote computing device 190 and use that information in combination with GNSS/GPS coordinate information to locate the mobile device 110.

In FIG. 1, the mobile device 110 may be a mobile device configured to include device locating functions (e.g., ‘Find My Phone’) for when the mobile device 110 is lost, stolen, and/or otherwise needs to be found. For example, at regular intervals or based on other triggering events (e.g., low battery threshold detected), the mobile device 110 may transmit its GPS information to the remote computing device 190 via a communication network 180. In addition, the mobile device 110 may use sensors to image surroundings, record sounds, and collect contextual information from the environment around the mobile device 110 that can be uploaded to a remote server from which the information may be obtained by a user via a system query to assist the user in locating the mobile device 110 at a later time.

As a general term used herein, “contextual information” may be any form of information that would be useful to a user to help in locating the mobile device 110, and in particular may include ambient audio inputs captured by one or more microphone(s) 112 and/or imagery (e.g., photos and/or video) captured by one or more camera(s) 114. Additionally, the mobile device 110 may collect contextual information from other sensors 116 (e.g., decibel meter, photometer, accelerometer, gyroscope, lidar, and/or radar) to detect aspects of where the mobile device 110 is and whether or how it is moving. mobile device

The microphone(s) 112 may be configured to receive audio inputs (i.e., sounds), which may include user utterances (i.e., speech) and/or background noise. The microphone(s) 112 may convert the received audio inputs to an electrical signal that may be provided to a processor 118 of the mobile device 110. Communicatively coupled between the microphone(s) 112 and the processor 118, or as part of the processor 118, the mobile device 110 may include audio hardware that converts the received electrical signals from the microphone(s) 112 using, for example, pulse code modulation (PCM).

The camera(s) 114 may be configured to receive video inputs, which may include photographs or video of the things, people, and/or creatures in the surroundings. The camera(s) 114 may convert the received video inputs to electrical signals that a mobile device processor 118 can analyze for content requiring anonymizing. The processor 118 of the mobile device may anonymize any detected private information (e.g., recorded audio data including speech and images including recognizable features of a person), and convert the anonymized information into digitized data packets for transmission.

The mobile device 110 may be configured by machine-readable instructions, which may include one or more instruction modules. The instruction modules may include computer program modules. In particular, the instruction modules may include one or more of the location information acquisition module 130, the sensor input analysis module 140, the anonymizing information module 150, the anonymized information uploading module 160, and/or other instruction modules.

The location information acquisition module 130 be configured to obtain information from one or more sensors of the mobile device 110. For example, the location information acquisition module 130 may obtain the electrical signals from the microphone(s) 112 and/or audio hardware of the mobile device 110. Alternatively, the location information acquisition module 130 may obtain digital image data from the camera(s) 114 and/or the other sensors 116. In addition, the location information acquisition module 130 may transmit or make available the obtained information to the sensor input analysis module 140.

The sensor input analysis module 140 may be configured to analyze any one or more of the converted sensor inputs from any sensor to detect contextual information in an environment from which the received sensor input was recorded by the mobile device 110. The sensor input analysis module 140 may include more than one module, each dedicated to one or more functions (e.g., audio analysis, video analysis, other sensor analysis, etc.).

The sensor input analysis module 140 may analyze the electrical signals from the microphone(s) 112 and/or audio hardware to distinguish and/or separate detected speech from ambient noise. Alternatively or additionally, the sensor input analysis module 140 may analyze the electrical signals from the microphone(s) 112 and/or audio hardware to recognize speech, such as performing voice recognition.

In some embodiments, speech recognition techniques may be used to transcribe the sounds of the speaker's voice into words and/or phrases that can be processed and stored by the mobile device 110. For example, the microphone(s) 112 of the mobile device 110 may record sounds of a conversation taking place near the mobile device. The processor 118 may then transcribe the recorded conversation sounds using speech recognition methods. Alternatively, speech recognition techniques may be used to detect that speech can be heard in the background, and include an indication of detected speech or a category of detected as the contextual information, avoiding transcribing the conversation as part of anonymizing the recorded audio. In this way, a quantified set of values and/or a mathematical descriptions may be developed and configured to be used, under a specified set of circumstances, for computer-based predictive analysis of an audio signal for automatic speech recognition, which includes translation of spoken language into words, text, and/or phrases. Various embodiments use models for speech recognition that account for background noise, location, and other considerations.

The sensor input analysis module 140 may extract background noise from the electrical signals from the microphone(s) 112 and/or audio hardware, which represents background noise. The extracted background noise may reflect ambient noise in the environment of the mobile device 110 without any accompanying speech that might contain private information, particularly information that could be subject to privacy laws and regulations. The sensor input analysis module 140 may then compile one or more samples of ambient noise from the surroundings of the mobile device 110 for inclusion in the anonymized information.

The sensor input analysis module 140 may analyze the electrical signals from the camera(s) 114 to detect faces or other recognizable parts of individual that may be present in the received video input. Alternatively or additionally, the sensor input analysis module 140 may analyze the electrical signals from the camera(s) 114 to detect text or symbols (names or logos) that may provide identifying information regarding individuals in the captured images. As a further alternative or addition, the sensor input analysis module 140 may analyze the electrical signals from the camera(s) 114 to classify the images or identifiable objects or things therein. As yet a further alternative or addition, the sensor input analysis module 140 may generate a text description of the images or identifiable objects or things therein and/or a determined classification thereof.

Image processing in various embodiments may use neural networks, knowledge-based, appearance-based, template matching, and/or other techniques for detecting faces, logos, and/or text containing private information visible in an image or video. Knowledge-based systems may use a set of rules based on human knowledge about imaging in order to identify faces, text, logos, or almost any object. Feature-based systems may extract structural features from an image and use classification/differentiation to identify faces, text, logos, or almost any object. Template matching uses pre-defined or parameterized facial templates to locate or detect faces, text, logos, or other objects by the correlation between the templates and input images. Appearance-based systems use a set of delegate training facial images to select an appropriate facial model. Similarly, other systems and techniques may be used or may be included as part of the image processing software in order to detect and identify faces, text, or logos. In addition, using lidar, computer vision, and/or any other range imaging techniques (e.g., an RGB-D camera), along with object recognition software, a processor may recognize objects or a category of objects. Objects may be recognized or categorized by the processor from distance measurements alone, as well as with a combination of distance measurements (e.g., lidar) with more conventional object recognition sensors (e.g., a computer vision system or an RGB-D camera).

Similar to the analysis of the audio and/or video inputs described above, the sensor input analysis module 140 may analyze the electrical signals from the other sensors 116 to identify characteristics of the surroundings of the mobile device 110. For example, the sensor input analysis module 140 may use electrical signals from a decibel meter to measure the noise level of the surroundings, a photometer to measure light levels of the surroundings, an accelerometer to measure how fast or whether the mobile device 110 is moving, a gyroscope to measure movement and/or orientation characteristics of the mobile device 110, and/or lidar and/or radar to detect the presence or characteristics of nearby objects. Any identified characteristics (i.e., contextual information) of the surroundings of the mobile device 110 may be included in the anonymized information compiled by the anonymizing information module 150.

Based on the detected contextual information, the sensor input analysis module 140 may determine a category or type of environment in which the received sensor inputs were generated. For example, the type of environment may include quiet, music, chatter (i.e., one or more other voices), machinery, vehicle cabin (e.g., car, plane, train), office, home, etc. The category or type of environment in which the received sensor inputs were generated may then be included in the anonymized information compiled by the anonymizing information module 150.

The anonymizing information module 150 may be configured to anonymize the information obtained by the location information acquisition module 130 and analyzed by the sensor input analysis module 140 to remove private information. For example, the anonymizing information module 150 may remove speech from an audio input of the mobile device to compile one or more samples of ambient noise from the surroundings for inclusion in the anonymized information. The anonymizing information module 150 may remove the speech, which was distinguished and/or separated by the sensor input analysis module 140. As a further example, the anonymizing information module 150 may classify the speech and/or ambient noise by comparing the speech and/or ambient noise to samples to determine the closest match(es) that share qualities or characteristics thereto. The classifications may be predetermined and generalized descriptions of the ambient noise, which will ensure no private information is retained. As a further example, the anonymizing information module 150 may generate a text description of the speech, ambient noise, and/or the determined classification thereof. In generating the text description, rules may be used that ensure no private information is included within the generated text description of the speech or ambient noise.

The anonymizing information module 150 may edit captured images from the camera(s) 114 to make unrecognizable (e.g., blurring, blocking, or otherwise obscuring) one or more faces detected by the sensor input analysis module 140. Making faces unrecognizable is one way of removing private information (i.e., the identity of the individual(s)). Alternatively or additionally, the anonymizing information module 150 may edit the captured images from the camera(s) 114 to make detected text or symbols unrecognizable (e.g., blurring, blocking, or otherwise obscuring). Making text or symbols unrecognizable may ensure people's names, employer names, and/or favorite brands are not included in the anonymized information. As another example, the anonymizing information module 150 may generate a text description of the images captured from the camera(s) 114 using the object recognition information determined by the sensor input analysis module 140. In generating the text description, rules may be used that ensure no private information is included within the generated text description of images. Alternatively, or additionally, the anonymizing information module 150 may generate a text description that includes a determined category of the images captured from the camera(s) 114.

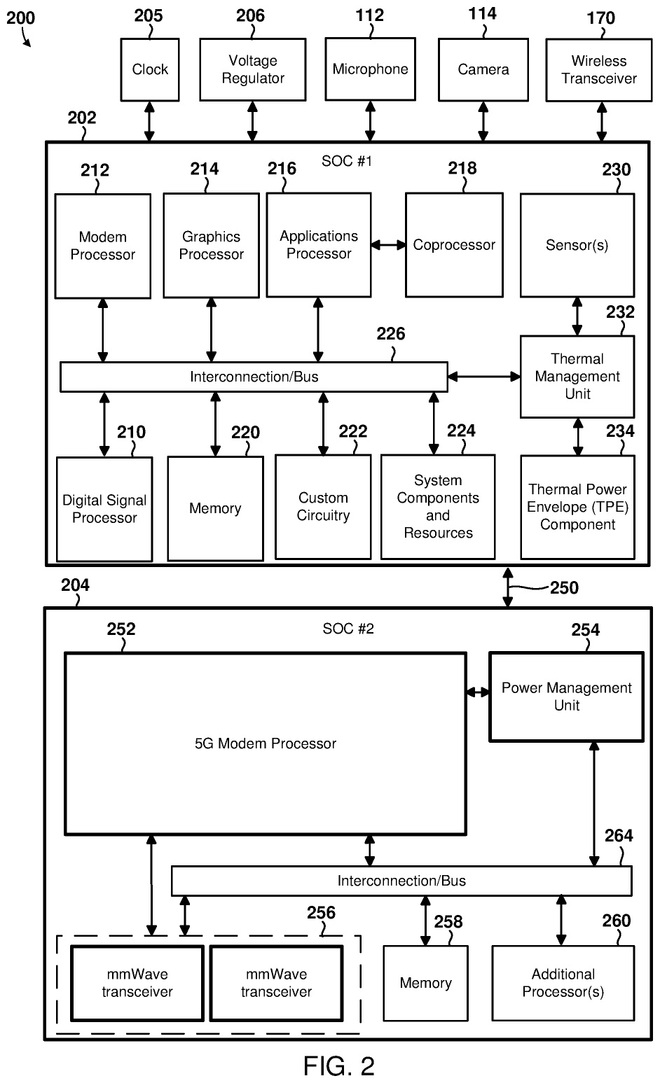

Whether audio, video, or other sensor data is analyzed by the sensor input analysis module 140 and/or anonymized by the anonymizing information module 150, the anonymizing information uploading module 160 may transmit the anonymized information to the remote computing device 190. In particular, the anonymizing information uploading module 160 may transmit the anonymized information to a wireless transceiver (e.g., 170 in FIG. 2) of the mobile device 110, which a processor may used to communicate via one or more wired and/or wireless communication links 125 with the remote computing device 190.

The transmitted anonymized information may also include additional information, such as what environment type was detected. The transmitted anonymized information may be transmitted on a schedule (every minute, hour, day, or some other interval). In addition, the anonymized information may be transmitted in response to certain conditions, such as when the mobile device battery is below a predetermined threshold (i.e., “low battery) or when wireless connectivity has resumed after an extended period. Alternatively, as a further alternative, anonymized information may be transmitted after a predetermined number of failures in such transmission (e.g., 10 failures).

The mobile device 110 may be communicatively coupled to peripheral device(s) (not shown) and configured to communicate with the remote computing device(s) 190 and/or other external resources (not shown) using the wireless transceiver and a communication network 180, such as a cellular communication network. The mobile device 110 may access the communication network 180 via one or more base stations, which in-turn may be communicatively coupled to the remote computing device(s) 190 through wired and/or wireless connections. Similarly, the remote computing device(s) 190 may be configured to communicate with the mobile device 110 and/or the external resources using the wireless transceiver and the communication network 180.

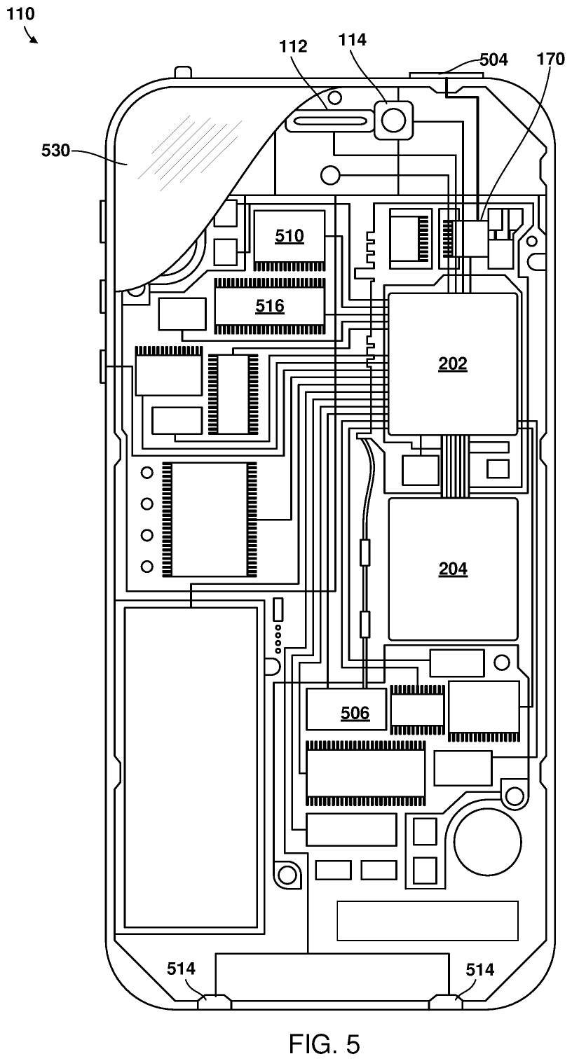

As described in more detail with reference to FIGS. 2 and 5, the mobile device 110 may include a plurality of hardware, software, and/or firmware components operating together to provide the functionality attributed herein to the mobile device 110. For example, the mobile device 110 may include one or more processors configured to execute computer program modules similar to those in the machine-readable instructions of the remote computing device(s) 190 described above.

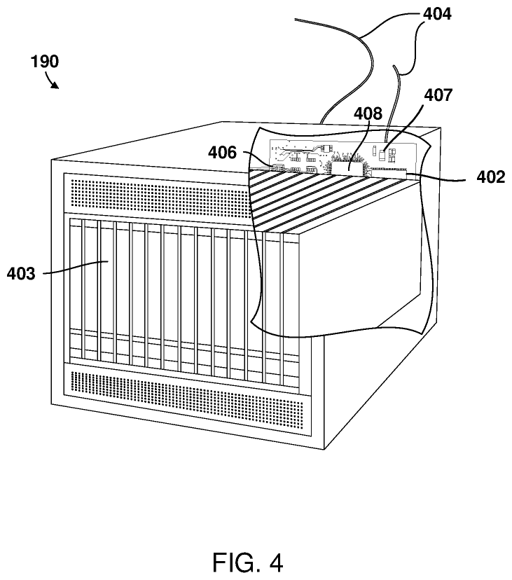

As described in more detail with reference to FIG. 4, the remote computing device 190 may include one or more processors configured to execute computer program modules similar to those in the machine-readable instructions of the mobile device 110. By way of non-limiting examples, remote computing devices may include one or more of a server, desktop computer, a laptop computer, a hand held computer, a tablet computing platform, a NetBook, a smartphone, a gaming console, and/or other computing platforms. The remote computing device(s) 190 may also include electronic storage (e.g., 402 in FIG. 4), one or more processors (e.g., 408 in FIG. 4), and/or other components. The remote computing device(s) 190 may include communication lines, or ports to enable the exchange of information with a network, other computing platforms, and many user mobile devices, such as the mobile device 110. Illustration of the remote computing device(s) 190 is not intended to be limiting. The remote computing device(s) 190 may include a plurality of hardware, software, and/or firmware components operating together to provide the functionality attributed herein to the remote computing device(s) 190.

Electronic storage (e.g., 220, 258 in FIG. 2) may include non-transitory storage media that electronically stores information. The electronic storage media of electronic storage may include one or both of system storage that is provided integrally (i.e., substantially non-removable) with the mobile device 110 or remote computing device(s) 190, respectively, and/or removable storage that is removably connectable thereto. For example, a port (e.g., a Universal Serial Bus (USB) port, a FireWire port, etc.) or a drive (e.g., a disk drive, etc.). The electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may include one or more virtual storage resources (e.g., cloud storage, a virtual private network, and/or other virtual storage resources). Also, the electronic storage may store software algorithms, information determined by processor(s), information received from the mobile device 110 or remote computing device(s) 190, respectively, that enables the mobile device 110 or remote computing device(s) 190, respectively to function as described herein.

Processor(s) (e.g., 118, 210, 212, 214, 218, 252, 260 in FIG. 2) may be configured to provide information processing capabilities in the mobile device 110 or remote computing device(s) 190, respectively. As such, the processor(s) may include one or more of a digital processor, an analog processor, a digital circuit designed to process information, an analog circuit designed to process information, a state machine, and/or other mechanisms for electronically processing information. Although processor(s) are shown in FIG. 2 as a single entity, this is for illustrative purposes only. In some implementations, processor(s) may include a plurality of processing units. These processing units may be physically located within the same device, or processor(s) may represent processing functionality of a plurality of devices, remote and/or local to one another, operating in coordination.

The processor(s) may be configured to execute the location information acquisition module 130, the sensor input analysis module 140, the anonymizing information module 150, the anonymized information uploading module 160, and/or other instruction modules. Processor(s) (e.g., 118, 210, 212, 214, 218, 252, 260 in FIG. 2), may be configured to execute the location information acquisition module 130, the sensor input analysis module 140, the anonymizing information module 150, the anonymized information uploading module 160, and/or other instruction modules by software; hardware; firmware; some combination of software, hardware, and/or firmware; and/or other mechanisms for configuring processing capabilities on processor(s). As used herein, the term “module” may refer to any component or set of components that perform the functionality attributed to the module. This may include one or more physical processors during execution of processor readable instructions, the processor readable instructions, circuitry, hardware, storage media, or any other components.

The descriptions of the functionality provided by the location information acquisition module 130, the sensor input analysis module 140, the anonymizing information module 150, and the anonymized information uploading module 160 described above and below are for illustrative purposes, and is not intended to be limiting, as those modules may provide more or less functionality than is described. For example, functionality described as being performed by one or more of the location information acquisition module 130, the sensor input analysis module 140, the anonymizing information module 150, the anonymized information uploading module 160, and/or other instruction modules may be eliminated, and some or all of its functionality may be provided by other modules. As another example, processor(s) 330 may be configured to execute one or more additional modules that may perform some or all of the functionality attributed to the location information acquisition module 130, the sensor input analysis module 140, the anonymizing information module 150, the anonymized information uploading module 160, and/or other instruction modules.

With reference to FIGS. 1 and 2, the illustrated example SIP 200 includes a two SOCs 202, 204, a clock 205, a voltage regulator 206, a microphone 112, a camera 114, and a wireless transceiver 170. In some embodiments, the first SOC 202 operates as central processing unit (CPU) of the wireless device that carries out the instructions of software application programs by performing the arithmetic, logical, control and input/output (I/O) operations specified by the instructions. In some embodiments, the second SOC 204 may operate as a specialized processing unit. For example, the second SOC 204 may operate as a specialized 5G processing unit responsible for managing high volume, high speed (e.g., 5 Gbps, etc.), and/or very high frequency short wavelength (e.g., 28 GHz mmWave spectrum, etc.) communications.

The first SOC 202 may include a digital signal processor (DSP) 210, a modem processor 212, a graphics processor 214, an application processor 216, one or more coprocessors 218 (e.g., vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 118, 210, 212, 214, 218, 252, 260 may include one or more cores, and each processor/core may perform operations independent of the other processors/cores. For example, the first SOC 202 may include a processor that executes a first type of operating system (e.g., FreeBSD, LINUX, OS X, etc.) and a processor that executes a second type of operating system (e.g., MICROSOFT® WINDOWS 10®). In addition, any or all of the processors 118, 210, 212, 214, 218, 252, 260 may be included as part of a processor cluster architecture (e.g., a synchronous processor cluster architecture, an asynchronous or heterogeneous processor cluster architecture, etc.).

The first SOC 202 and the second SOC 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 and/or custom circuitry 222 may also include circuitry to interface with peripheral devices, such as cameras, electronic displays, wireless communication devices, external memory chips, etc.

The first SOC 202 and the second SOC 204 may communicate via interconnection/bus module 250. The various processors 118, 210, 212, 214, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first SOC 202 and/or second SOC 204 may further include an input/output module (not illustrated) for communicating with resources external to the SOC, such as a clock 205 and a voltage regulator 206. Resources external to the SOC (e.g., clock 205, voltage regulator 206) may be shared by two or more of the internal SOC processors/cores.

In addition to the example SIP 200 discussed above, various embodiments may be implemented in a wide variety of computing systems, which may include a single processor, multiple processors, multicore processors, or any combination thereof.

Various embodiments may be implemented using a number of single processor and multiprocessor computer systems, including a system-on-chip (SOC) or system in a package (SIP). FIG. 2 illustrates an example computing system or SIP 200 architecture that may be used in mobile device (e.g., 110), remote computing devices (e.g., 190), or other systems for implementing the various embodiments.

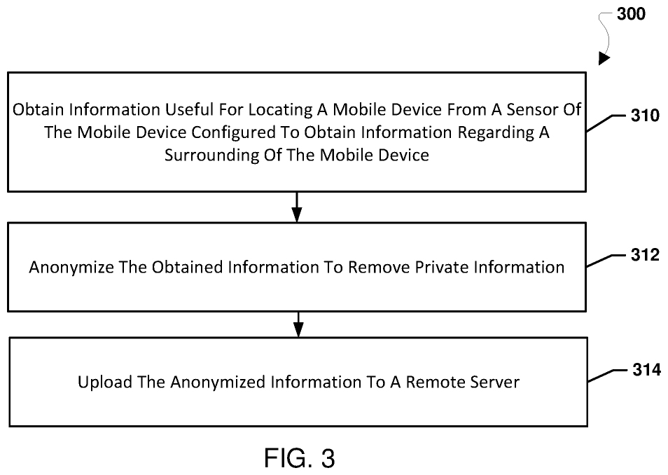

FIG. 3 illustrates operations of method 300 of assisting a user in locating a mobile device executed by a processor of the mobile device in accordance with various embodiments. With reference to FIGS. 1-3, the operations of the method 300 may be accomplished with one or more additional operations not described, and/or without one or more of the operations discussed. Additionally, the order in which the operations of the method 300 are illustrated in FIG. 3 and described below is not intended to be limiting.

In some embodiments, the method 300 may be implemented in one or more processors (e.g., a digital processor, an analog processor, a digital circuit designed to process information, an analog circuit designed to process information, a state machine, and/or other mechanisms for electronically processing information) in response to instructions stored electronically on an electronic storage medium of a mobile device. The one or more processors may include one or more devices configured through hardware, firmware, and/or software to be specifically designed for execution of one or more of the operations of the method 300. For example, with reference to FIGS. 1-3, the operations of the method 300 may be performed by a processor (e.g., 118, 210, 212, 214, 218, 252, 260) of a computing device (e.g., 110, 190).

FIG. 3 illustrates a method 300 in accordance with one or more implementations.

In block 310, the processor of a mobile device (e.g., 110) may perform operations including obtaining information useful for locating the mobile device from a sensor (e.g., 112, 114, 116) of the mobile device configured to obtain information regarding surroundings of the mobile device. For example, a processor may use audio processing techniques that identify and separate speech from ambient noise within sounds detected by the microphone(s) of the mobile device. By distinguishing the speech from ambient noise various embodiments may use information about either part of the audio input to generate anonymized information. In block 310, the processor of the mobile device may use location information acquisition module (e.g., 130) to obtain information useful for locating the mobile device from the microphone(s) (e.g., 112), the camera(s) (e.g., 114), and/or the one or more other sensor(s) (e.g., 116). In various embodiments, means for performing the operations of block 310 may include a processor (e.g., 118, 210, 212, 214, 218, 252, 260) coupled to the microphone (e.g., 112), the camera (e.g., 114), other sensor(s) (e.g., 116) and electronic storage (e.g., 220, 258).

In some embodiments, in block 310 the processor may use one or more sensor readings (e.g., ambient light present/absent; a value/magnitude of ambient light), accelerometer (e.g., does the mobile device periodically move, such as being in someone's pocket or in a sofa while someone is sitting on the sofa). In some embodiments mathematical models may be used to determine/recognize what mobile device movements correspond to, such as in a pocket of a walking person or person in car, laying in a sofa seat while a person sits on the coach and breathes, shifts, gets up, etc.), gyroscope (e.g., provide readings of the device orientation—such as laying flat, standing upright, some angle there between). In further embodiments, the sensor readings may be anonymized as well, or not.

In block 312, the processor of a mobile device may perform operations including anonymizing the obtained information to remove private information. In some embodiments, a processor may further process the speech and/or ambient noise, separated using audio processing techniques, to strip away or eliminate private information contained in the obtained information. Conventional speech recognition system strip away ambient noise to enhance speech recognition. In contrast, various embodiments may the reverse by using the ambient noise after removing the speech. In this way, the detected speech is basically subtracted from the audio input (i.e., detected sounds) in order to strip away identifying voices and leave just ambient noise for inclusion in the anonymized information that gets uploaded to the server.

In some embodiments, instead of using samples of the ambient noise as the anonymized information, a processor may apply a noise recognition model that would determine a classification of the detected ambient noise, which may be saved as the anonymized information. In some embodiments, the classification of the detected ambient noise may be part of a text description of the ambient noise, which defines the anonymized information. In this way, the anonymized information may include descriptions like “television is heard in the background,” “traffic noise is heard prominently,” or “no ambient sound detected.” E.g., “humans, bright light, television present nearby.” In some embodiments, the same audio processing techniques may be used to identify the speech, but rather than saving an audio sample of the speech alone or a direct speech to text transcription, the mobile device may generate a basic description of what the audio sample contains, such as “speech is heard in the background.”

In some embodiments, a processor may use an imaging/video scrubbing algorithm that identifies faces and body parts (such as for facial recognition, auto-focusing of cameras, etc.) to identify the portions of an image containing person-recognizable features (e.g., the face, torso, etc.), and then erase, fuzz/defocus, or black the pixels encompassing those portions of the image. Such processed images/video may be considered anonymized information that may be uploaded to the server.

In some embodiments, the mobile device may have more than one camera, such as one on each side of the device. Various embodiments may consider/analyze what each camera captures (e.g., if facing down, a front camera may show darkness, but the rear camera may show something else); vice versa for when the device is facing upward; but both cameras may be dark the mobile device is covered by one or more objects. In some embodiments, a processor may use a visual scrubbing algorithm that identifies text or brands (text recognition or image recognition), like name tags or logos, which the processor may obscure my erasing, fuzzing, defocusing, covering, etc. In some embodiments, a processor may perform object recognition on objects detected in a visual image captured by a camera of the mobile device and generate a text description thereof and/or identify a category for any recognized objects, which text description and/or category may be included in the anonymized information.

In block 312, the processor of the mobile device may anonymize the obtained information using the sensor input analysis module (140) and the anonymizing information module (e.g., 150). In various embodiments, means for performing the operations of block 312 may include a processor (e.g., 118, 210, 212, 214, 218, 252, 260) coupled to electronic storage (e.g., 220, 258).

In block 314, the processor of a mobile device may perform operations including uploading the anonymized information to a remote computing device (e.g., 190). In some embodiments, the processor may upload the anonymized information to the remote computing device periodically, such as every five minutes, once an hour, once a day, according to a predefined schedule, etc. In some embodiments, the processor may upload the anonymized information to the remote computing device in response to a trigger event, such as in response to a query, message or ping seeking information on the location of the mobile device.

In some embodiments, the processor may be configured to recognize conditions indicative that the mobile device may be misplaced, and upload the anonymized information to the remote computing device in response to determining that the mobile device may be misplaced. The processor may determine whether the mobile device is misplaced using any of the types of sensor data discussed above. Alternatively, or additionally, the determination as to whether the mobile device is misplaced may use additional resources of the mobile device. For example, after a predetermined period of non-use or immobility (e.g., changes or lack of changes in GPS coordinates), the mobile device may be considered misplaced. In addition, or alternatively, if a battery level of the mobile device falls below a predetermined threshold (e.g., 5%), the mobile device may be considered misplaced since once the mobile device runs out of power it will no longer be able to upload information. In addition, or alternatively, if the mobile device is powering off or shutting down, the mobile device may be considered misplaced since once the mobile device is turned off it will no longer be able to upload information. As yet a further addition or alternative, the mobile device may be considered misplaced in response to a user manually entering a command to upload anonymized information to the remote computing device.

In block 314, the processor of the mobile device may output the results of the speech recognition analysis using a transceiver (e.g., 170) of the mobile device and/or the anonymized information uploading module (e.g., 160). In various embodiments, means for performing the operations of block 314 may include a processor (e.g., 118, 210, 212, 214, 218, 252, 260) coupled to electronic storage (e.g., 220, 258) and a transceiver (e.g., 170).

In some embodiments, the processor may repeat any or all of the operations in blocks 310, 312, and 314 to repeatedly or obtain audio, video and other contextual information, anonymize the obtained information, and transmit the anonymized information to a remote computing device.

Various embodiments (including, but not limited to, embodiments discussed above with reference to FIGS. 1-3) may be implemented on a variety of remote computing devices, an example of which is illustrated in FIG. 4 in the form of a server. With reference to FIGS. 1-4, the remote computing device 190 may include a processor 408 coupled to volatile memory 402 and a large capacity nonvolatile memory, such as a disk drive 403. The network mobile device 190 may also include a peripheral memory access device such as a floppy disc drive, compact disc (CD) or digital video disc (DVD) drive 406 coupled to the processor 408. The remote computing device 190 may also include network access ports 404 (or interfaces) coupled to the processor 408 for establishing data connections with a network, such as the Internet and/or a local area network coupled to other system computers and servers. The remote computing device 190 may include one or more antennas 407 for sending and receiving electromagnetic radiation that may be connected to a wireless communication link. The remote computing device 190 may include additional access ports, such as USB, Firewire, Thunderbolt, and the like for coupling to peripherals, external memory, or other devices.

The various aspects (including, but not limited to, embodiments discussed above with reference to FIGS. 1-3) may be implemented on a variety of mobile device, an example of which is illustrated in FIG. 5 in the form of a mobile device. With reference to FIGS. 1-5, the mobile device 110 may include a first SoC 202 (e.g., a SoC-CPU) coupled to a second SoC 204 (e.g., a 5G capable SoC) and a third SoC 506 (e.g., a C-V2X SoC configured for managing V2V, V2I, and V2P communications over D2D links, such as D2D links establish in the dedicated Intelligent Transportation System (ITS) 5.9 GHz spectrum communications). The first, second, and/or third SoCs 202, 204, and 506 may be coupled to internal memory 516, a display 530, speakers 514, a microphone 112, and a wireless transceiver 170. Additionally, the mobile device 110 may include one or more antenna 504 for sending and receiving electromagnetic radiation that may be connected to the wireless transceiver 170 (e.g., a wireless data link and/or cellular transceiver, etc.) coupled to one or more processors in the first, second, and/or third SoCs 202, 204, and 506. Mobile devices 110 may also include menu selection buttons or switches for receiving user inputs.

Mobile devices 110 may additionally include a sound encoding/decoding (CODEC) circuit 510, which digitizes sound received from the microphone 112 into data packets suitable for wireless transmission and decodes received sound data packets to generate analog signals that are provided to the speaker to generate sound and analyze ambient noise or speech. Also, one or more of the processors in the first, second, and/or third SoCs 202, 204, and 506, wireless transceiver 170 and CODEC circuit 510 may include a digital signal processor (DSP) circuit (not shown separately).

The processors implementing various embodiments may be any programmable microprocessor, microcomputer or multiple processor chip or chips that can be configured by software instructions (applications) to perform a variety of functions, including the functions of the various aspects described in this application. In some communication devices, multiple processors may be provided, such as one processor dedicated to wireless communication functions and one processor dedicated to running other applications. Typically, software applications may be stored in the internal memory before they are accessed and loaded into the processor. The processor may include internal memory sufficient to store the application software instructions.

Implementation examples are described in the following paragraphs. While some of the following implementation examples are described in terms of example methods, further example implementations may include: the example methods discussed in the following paragraphs implemented by a mobile device including a processor configured to perform operations of the example methods; the example methods discussed in the following paragraphs implemented by a mobile device including a modem processor configured to perform operations of the example methods; the example methods discussed in the following paragraphs implemented by a mobile device including means for performing functions of the example methods; the example methods discussed in the following paragraphs implemented in a processor use in a mobile device that is configured to perform the operations of the example methods; and the example methods discussed in the following paragraphs implemented as a non-transitory processor-readable storage medium having stored thereon processor-executable instructions configured to cause a processor or modem processor of a wireless device to perform the operations of the example methods.

Example 1. A method of assisting a user in locating a mobile device executed by a processor of the mobile device, including: obtaining information useful for locating the mobile device from a sensor of the mobile device configured to obtain information regarding surroundings of the mobile device; anonymizing the obtained information to remove private information; and uploading the anonymized information to a remote server.

Example 2. The method of example 1, in which uploading the anonymized information to a remote server includes uploading the anonymized information to a remote server in response to determining that the mobile device may be misplaced.

Example 3. The method of either of examples 1 or 2, in which anonymizing the obtained information to remove private information includes removing speech from an audio input of the mobile device to compile one or more samples of ambient noise from the surroundings of the mobile device for inclusion in the anonymized information.

Example 4. The method of any of examples 1-3, in which anonymizing the obtained information to remove private information includes determining which of one or more predetermined categories of ambient noise are included within an audio input of the mobile device, in which the anonymized information indicates the determined one or more predetermined categories of ambient noise.

Example 5. The method of any of examples 1-4, in which the anonymized information indicates a text description of ambient noise that includes the determined one or more predetermined categories of ambient noise.

Example 6. The method of any of examples 1-5, in which anonymizing the obtained information to remove private information includes converting speech to text and generating a generalized description of the converted speech, in which the anonymized information includes the generalized description of the speech converted to text.

Example 7. The method of any of examples 1-6, in which anonymizing the obtained information to remove private information includes editing an image captured by a video input of the mobile device to make images of individuals detected within the captured image unrecognizable, in which the anonymized information includes the edited image.

Example 8. The method of any of examples 1-7, in which anonymizing the obtained information to remove private information includes editing an image captured by a video input of the mobile device to make unrecognizable identifying information associated with an individual detected within the captured image, in which the anonymized information includes the edited image.

Example 9. The method of any of examples 1-8, in which anonymizing the obtained information to remove private information includes determining which of one or more predetermined categories of visual elements are included within an image captured by a camera of the mobile device, in which the anonymized information indicates the determined one or more predetermined categories of visual elements.

Example 10. The method of any of examples 1-9, in which anonymizing the obtained information to remove private information includes compiling a text description of one or more visual elements within an image captured by a camera of the mobile device, in which the anonymized information indicates the compiled text description.

A number of different cellular and mobile communication services and standards are available or contemplated in the future, all of which may implement and benefit from the various aspects. Such services and standards may include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020™), EDGE, advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), integrated digital enhanced network (iDEN), C-V2X, V2V, V2P, V2I, and V2N, etc. Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various aspects illustrated and described are provided merely as examples to illustrate various features of the claims. However, features shown and described with respect to any given aspect are not necessarily limited to the associated aspect and may be used or combined with other aspects that are shown and described. Further, the claims are not intended to be limited by any one example aspect. For example, one or more of the operations of the methods may be substituted for or combined with one or more operations of the methods.

The foregoing method descriptions and the process flow diagrams are provided merely as illustrative examples and are not intended to require or imply that the operations of various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the aspects disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such aspect decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make or use the claims. Various modifications to these aspects will be readily apparent to those skilled in the art, and the generic principles defined herein may be applied to other aspects without departing from the scope of the claims. Thus, the present disclosure is not intended to be limited to the aspects shown herein but is to be accorded the widest scope consistent with the following claims and the principles and novel features disclosed herein.

What is claimed is:

1. A method of assisting a user in locating a mobile device executed by a processor of the mobile device, comprising:
obtaining information useful for locating the mobile device from a sensor of the mobile device configured to obtain information regarding surroundings of the mobile device;
anonymizing the obtained information to remove private information; and
uploading the anonymized information to a remote server.

2. The method of claim 1, wherein uploading the anonymized information to a remote server comprises uploading the anonymized information to a remote server in response to determining that the mobile device may be misplaced.

3. The method of claim 1, wherein anonymizing the obtained information to remove private information includes removing speech from an audio input of the mobile device to compile one or more samples of ambient noise from the surroundings of the mobile device for inclusion in the anonymized information.

4. The method of claim 1, wherein anonymizing the obtained information to remove private information includes determining which of one or more predetermined categories of ambient noise are included within an audio input of the mobile device, wherein the anonymized information indicates the determined one or more predetermined categories of ambient noise.

5. The method of claim 4, wherein the anonymized information indicates a text description of ambient noise that includes the determined one or more predetermined categories of ambient noise.

6. The method of claim 1, wherein anonymizing the obtained information to remove private information includes converting speech to text and generating a generalized description of the converted speech, wherein the anonymized information includes the generalized description of the speech converted to text.

7. The method of claim 1, wherein anonymizing the obtained information to remove private information includes editing an image captured by a video input of the mobile device to make images of individuals detected within the captured image unrecognizable, wherein the anonymized information includes the edited image.

8. The method of claim 1, wherein anonymizing the obtained information to remove private information includes editing an image captured by a video input of the mobile device to make unrecognizable identifying information associated with an individual detected within the captured image, wherein the anonymized information includes the edited image.

9. The method of claim 1, wherein anonymizing the obtained information to remove private information includes determining which of one or more predetermined categories of visual elements are included within an image captured by a camera of the mobile device, wherein the anonymized information indicates the determined one or more predetermined categories of visual elements.

10. The method of claim 1, wherein anonymizing the obtained information to remove private information includes compiling a text description of one or more visual elements within an image captured by a camera of the mobile device, wherein the anonymized information indicates the compiled text description.

11. A mobile device, comprising:
a sensor configured to obtain information regarding surroundings of the mobile device; and
a processor coupled to the sensor and configure to:
obtain information for locating the mobile device from the sensor;
anonymize the obtained information to remove private information; and
upload the anonymized information to a remote server.

12. The mobile device of claim 11, wherein the processor is configure to upload the anonymized information to a remote server in response to determining that the mobile device may be misplaced.

13. The mobile device of claim 11, wherein the processor is configure to anonymize the obtained information to remove private information by removing speech from an audio input of the mobile device to compile one or more samples of ambient noise from the surroundings of the mobile device for inclusion in the anonymized information.

14. The mobile device of claim 11, wherein the processor is configure to anonymize the obtained information to remove private information by determining which of one or more predetermined categories of ambient noise are included within an audio input of the mobile device, wherein the anonymized information indicates the determined one or more predetermined categories of ambient noise.

15. The mobile device of claim 14, wherein the processor is configure to anonymize the obtained information to remove private information by generating information indicates a text description of ambient noise that includes the determined one or more predetermined categories of ambient noise.

16. The mobile device of claim 11, wherein the processor is configure to anonymize the obtained information to remove private information by converting speech to text and generating a generalized description of the converted speech, wherein the anonymized information includes the generalized description of the speech converted to text.

17. The mobile device of claim 11, wherein the processor is configure to anonymize the obtained information to remove private information by editing an image captured by a video input of the mobile device to make images of individuals detected within the captured image unrecognizable, wherein the anonymized information includes the edited image.

18. The mobile device of claim 11, wherein the processor is configure to anonymize the obtained information to remove private information by editing an image captured by a video input of the mobile device to make unrecognizable identifying information associated with an individual detected within the captured image, wherein the anonymized information includes the edited image.

19. The mobile device of claim 11, wherein the processor is configure to anonymize the obtained information to remove private information by determining which of one or more predetermined categories of visual elements are included within an image captured by a camera of the mobile device, wherein the anonymized information indicates the determined one or more predetermined categories of visual elements.

20. The mobile device of claim 11, wherein the processor is configure to anonymize the obtained information to remove private information by compiling a text description of one or more visual elements within an image captured by a camera of the mobile device, wherein the anonymized information indicates the compiled text description.

21. A mobile device, comprising:
means for obtaining information for locating the mobile device from a sensor configured to obtain information regarding surroundings of the mobile device;
means for anonymizing the obtained information to remove private information; and
means for uploading the anonymized information to a remote server in response to determining that the mobile device may be misplaced.

22. The mobile device of claim 21, wherein means for uploading the anonymized information to a remote server comprises means for uploading the anonymized information to a remote server in response to determining that the mobile device may be misplaced.

23. The mobile device of claim 21, wherein means for anonymizing the obtained information to remove private information comprises means for removing speech from an audio input of the mobile device to compile one or more samples of ambient noise from the surroundings of the mobile device for inclusion in the anonymized information.

24. The mobile device of claim 21, wherein means for anonymizing the obtained information to remove private information comprises means for determining which of one or more predetermined categories of ambient noise are included within an audio input of the mobile device, wherein the anonymized information indicates the determined one or more predetermined categories of ambient noise.

25. The mobile device of claim 21, wherein means for anonymizing the obtained information to remove private information comprises means for converting speech to text and generating a generalized description of the converted speech, wherein the anonymized information includes the generalized description of the speech converted to text.

26. The mobile device of claim 21, wherein means for anonymizing the obtained information to remove private information comprises means for editing an image captured by a video input of the mobile device to make images of individuals detected within the captured image unrecognizable, wherein the anonymized information includes the edited image.

27. The mobile device of claim 21, wherein means for anonymizing the obtained information to remove private information comprises means for editing an image captured by a video input of the mobile device to make unrecognizable identifying information associated with an individual detected within the captured image, wherein the anonymized information includes the edited image.

28. The mobile device of claim 19, wherein means for anonymizing the obtained information to remove private information comprises means for determining which of one or more predetermined categories of visual elements are included within an image captured by a camera of the mobile device, wherein the anonymized information indicates the determined one or more predetermined categories of visual elements.

29. The mobile device of claim 19, wherein means for anonymizing the obtained information to remove private information comprises means for compiling a text description of one or more visual elements within an image captured by a camera of the mobile device, wherein the anonymized information indicates the compiled text description.

30. A non-transitory processor-readable medium having stored thereon processor-executable instructions configured to cause a processor of a mobile device to perform operations comprising:
obtaining information useful for locating the mobile device from a sensor of the mobile device configured to obtain information regarding surroundings of the mobile device;
anonymizing the obtained information to remove private information; and
uploading the anonymized information to a remote server in response to determining that the mobile device may be misplaced.
